(19) United States
(12) Patent Application Publication
(10) Pub. No.: US 2004/0193390 A1
(43) Pub. Date: Sep. 30, 2004

(54) Method and apparatus for rapid evaluation of component mismatch in integrated circuit performance

(76) Inventors: Patrick G. Drennan, Gilbert, AZ (US); Colin C. McAndrew, Phoenix, AZ (US); Gamal Hegazi, Chandler, AZ (US); Cynthia Recker, Mesa, AZ (US)

Correspondence Address: FULBRIGHT & JAWORSKI L.L.P., 600 CONGRESS AVE., SUITE 2400, AUSTIN, TX, 78701, US

(21) Appl. No.: 10/403,435

(22) Filed: Mar. 31, 2003

(51) Int. Cl. G06F 17/10

(52) U.S. Cl. 703/2

(57) ABSTRACT

A method for evaluating component mismatch in a circuit includes performing a nominal circuit simulation, selecting a set of matched devices, each matched device having at least one process parameter associated therewith, altering a process parameter by one standard deviation, executing an altered circuit simulation, determining a deviation from a nominal value of at least one circuit performance measure, and repeating the altering, executing and determining steps for each process parameter of each matched device. A mismatch evaluation tool includes a computer, a user interface coupled to the computer, and a program storage device coupled to the computer, and embodying a mismatch evaluator.

### BACKGROUND OF THE INVENTION

1. Field of the Invention

The invention relates generally to the field of circuit simulation and optimization.

2. Discussion of the Related Art

Mismatch is a leading cause of yield loss and a determining factor of circuit performance in analog, mixed-signals (AMS) integrated circuits (ICs). Unfortunately, most commercially available circuit optimization tools do not consider mismatch effects.

AnalogXpert™, available from Celestry Design Technologies (San Jose, Calif.), is an example of an unsatisfactory approach to solving the above-discussed problem. This mismatch tool provides analysis in a pair-wise fashion using Monte Carlo simulations (or “casing”). A problem with this technology is that it does not take into consideration bias conditions and geometry, necessary for accurate mismatch variation calculations.

Another problem with this technology is that, because it only applies to pair-wise elements, it cannot be used for a number of analog circuit blocks such as, for example, data converters, multiple output current mirrors, and receiver and transmitter I and Q channels.

What is needed is a method and apparatus for evaluating banks of matched devices in any arbitrary manner, including dissimilar device geometries and device types, in a circuit simulation or optimization environment.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same or similar elements. The invention may be better understood by reference to one or more of these drawings in combination with the description presented herein. It should be noted that the features illustrated in the drawings are not necessarily drawn to scale.

FIG. 1 is a block diagram a mismatch evaluation tool, representing an embodiment of the invention.

FIG. 2 is a flowchart of a mismatch evaluation method, representing an embodiment of the invention.

FIG. 3 is a circuit diagram created with a circuit simulation program, illustrating an embodiment of the invention.

FIG. 4 is a screenshot of an output setting window, representing an embodiment of the invention.

FIG. 5 is a screenshot of a circuit simulation window, representing an embodiment of the invention.

FIG. 6 is a screenshot of a matched device selection form, representing an embodiment of the invention.

FIG. 7 is a screenshot of a performance form, representing an embodiment of the invention.

FIG. 8 is a screenshot of a run form, representing an embodiment of the invention.

FIG. 9 is a screenshot of a popup window, representing an embodiment of the invention.

FIG. 10 is a screenshot of a results form, representing an embodiment of the invention.

FIG. 11 is a screenshot of a detailed contributions breakdown form, representing an embodiment of the invention.

### DETAILED DESCRIPTION

The invention and the various features and advantageous details thereof are explained more fully with reference to the nonlimiting embodiments that are illustrated in the accompanying drawings and detailed in the following description. It should be understood that the detailed description and the specific examples, while indicating specific embodiments of the invention, are given by way of illustration only and not by way of limitation. Various substitutions, modifications, additions and/or rearrangements within the spirit and/or scope of the underlying inventive concept will become apparent to those of ordinary skill in the art from this disclosure.

The invention may include a method and/or apparatus for evaluating a mismatch contribution to circuit performance. In one embodiment, the invention may be used within a circuit simulation environment for including mismatch design objectives into circuit optimization tools. As one of ordinary skill in the art will recognize in light of this disclosure, the invention may be applied in any form of circuit analysis including, for example, DC, AC, transient, and harmonic balance analysis.

According to an aspect of the invention, a method for evaluating component mismatch in a circuit includes performing a nominal circuit simulation, selecting a set of matched devices; each matched device having at least one process parameter associated therewith; altering a process parameter by one standard deviation, executing an altered circuit simulation, determining a deviation from a nominal value of a circuit performance measure, and repeating the altering, executing and determining steps for each process parameter of each matched device.

According to another aspect of the invention, a mismatch evaluation tool, comprising a computer, a user interface coupled to the computer, and a program storage device coupled to the computer, the program storage device further embodying a mismatch evaluator which, at least: allows a user to perform a nominal circuit simulation, allows the user to select a set of matched devices, each matched device having at least one process parameter associated therewith, alters a process parameter by one standard deviation, executes an altered circuit simulation, determines a deviation from a nominal value of a circuit performance measure, and repeats the altering, executing and storing steps for each process parameter of each matched device.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

Referring to FIG. 1, a block diagram of a mismatch evaluation tool 100 is depicted according to an exemplary embodiment of the invention. In one embodiment, the mismatch tool 100 comprises a mismatch model described by:

$${σ}_{{E}_{k}}^{2} = {\sum }_{i , j} {( \frac{\partial {E}_{k}}{\partial {p}_{i , j}} )}^{2} {σ}_{{p}_{i , j}}^{2} ( geometry ) \qquad Equation 1$$

where:

p_{i,j} is the i^{th} process parameter for the j^{th} device;

Eₖ is the k^{th} circuit performance measure (e.g., gain, phase margin); and

σ is the standard deviation.

The invention may include using the model described by equation 1 and accumulating the values of

$${( \frac{\partial {E}_{k}}{\partial {p}_{i , j}} )}^{2} ,$$

which may be numerically evaluated using 1-sigma (one standard deviation) perturbations in the individual process parameters p_{i,j}. The sum of the squared sensitivities is the variation of Eₖ, which is the design objective. With this model, any number of arbitrarily selected devices and device types may be combined, and simulations are not restricted to pair-wise combinations of devices.

In another embodiment, the partial derivative in equation 1 may be split into two components:

$${σ}_{{E}_{k}}^{2} = {\sum }_{i , j} {( \frac{\partial E}{\partial {e}_{j}} )}^{2} {( \frac{\partial {e}_{j}}{\partial {p}_{i , j}} )}^{2} {σ}_{{p}_{i , j}}^{2} ( geometry ) \qquad Equation 2$$

where:

e is the electrical performance (e.g. I_{d}, gₘ, etc) for a single device.

In the course of evaluating Equation 1, the entire circuit must be re-simulated for each perturbation in the process parameter p_{i,j}. Splitting the partial derivative means that terms

$${( \frac{\partial E}{\partial {e}_{j}} )}^{2} and {( \frac{\partial {e}_{j}}{\partial {p}_{i , j}} )}^{2}$$

may be evaluated independently and more efficiently. Term

$${( \frac{\partial E}{\partial {e}_{j}} )}^{2}$$

only needs to be evaluated once per device (i.e., transistor, resistor, capacitor, diode, varactor) for the entire circuit. The term

$${( \frac{\partial {e}_{j}}{\partial {p}_{i , j}} )}^{2}$$

needs to be evaluated for each process parameter (typically 9 to 11 process parameters per device), but this evaluation can be performed on a single device. By separating these two components, the statistical simulation time may be significantly reduced.

In one embodiment, the process parameters may be written as:

p=p_{no min al}+Nsmm×σ_{p,mismatch} Equation 3

where the pₙₒₘᵢₙₐₗ (nominal process parameter value), σ_{p,mismatch} (mismatch standard deviation of pₙₒₘᵢₙₐₗ), and Nsmm (number of standard deviations) for each process parameter are defined in a model file. In this case, the process of Equation 1 can be done in a single step, without requiring explicit evaluation of the sensitivities

$$\frac{\partial {E}_{k}}{\partial {p}_{i , j}} ,$$

as this is done implicitly during the simulation of the circuit electrical performances.

Still referring to FIG. 1, the mismatch tool 100 may comprise a mismatch evaluator program 115, which is run upon a computer, or server, 105. The computer 105 is electronically connected to a circuit simulation software 110. The circuit simulation software 110 may include any of the many electronic circuit modeling and simulation packages commercially available. Some examples include the SPICE program developed by the University of California (Berkeley, Calif.), but may also include PSPICE, MCSPICE, Saber, SmartSpice, etc.

In one embodiment, the circuit simulation program 110 may be Analog Artist™ available from Cadence Design Systems (San Jose, Calif.). In another embodiment, the mismatch evaluator 115 may be integrated into the circuit simulation program 110 and may be accessible via a menu. The integration between the mismatch evaluator 115 and the circuit simulation software 110 may be a seamless framework that automatically detects all the pertinent session data, such as, simulator type, analysis type, technology model library, design parameters and output variables.

The mismatch tool 100 further comprises a mismatch data library 120. The mismatch data library 120 comprises process parameter variables used within the mismatch evaluator 115 to account for the physical parameters affecting mismatch. A user interface 125 is connected to the computer 105 and may provide the user with input/output apparatus for controlling or using the mismatch tool 100.

In practice, the circuit simulation software 110, the mismatch evaluator 115, and the mismatch data library 120 may comprise instructions stored a program storage media 130. The program storage media 130 may be any type of readable memory including, for example, a magnetic or optical media such as a card, tape or disk, or a semiconductor memory such as a PROM or FLASH memory.

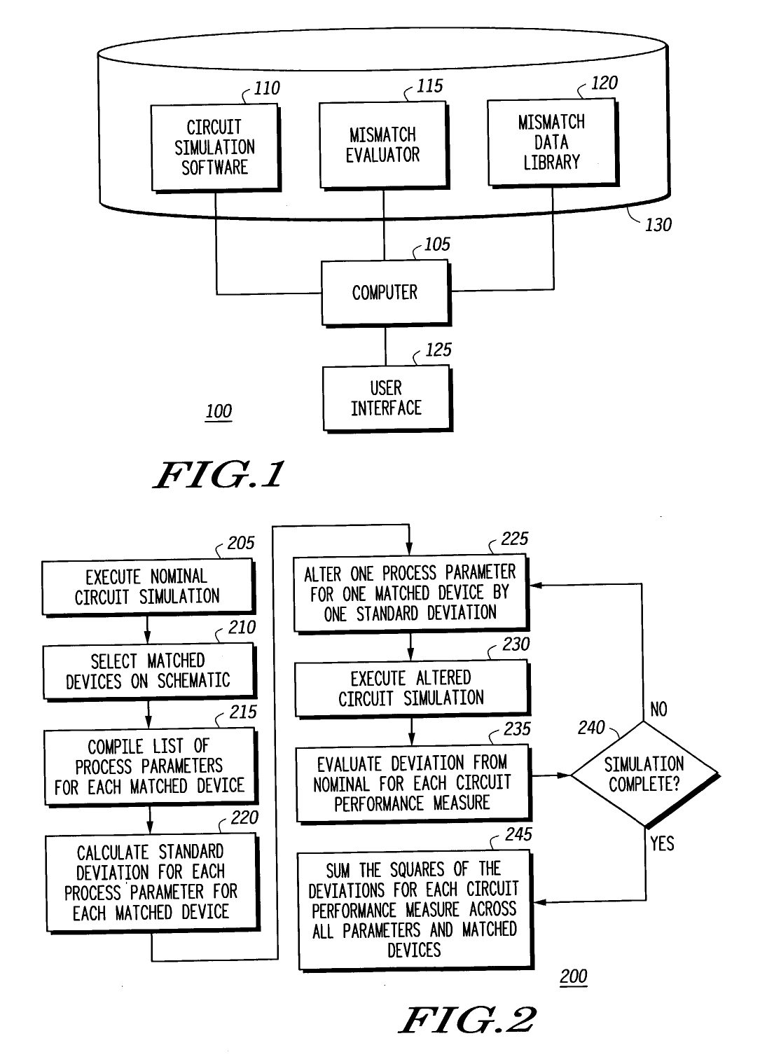

The mismatch evaluator 115 may calculate the total mismatch sigma of a circuit by utilizing the method 200 detailed in FIG. 2. The outputs of the mismatch evaluator 115 may also include a sensitivity analysis that details the breakdown of all contributions (to the total mismatch sigma) from the different mismatch parameters of each device.

In an embodiment of the invention, the mismatch tool 100 comprises a plurality of different circuit calculation scenarios: a Voltage Driven scenario, a Current Mirror scenario, and a Differential Pair scenario, for MOSFET and BJT transistor devices; and a resistor calculation scenario and capacitor calculation scenario. Each of these calculation scenarios may be combined with calculations for other analog design objectives. Additional calculation scenarios other than these five are possible, and are also within the spirit and scope of the invention.

In another embodiment, a mismatch evaluator menu may include, for example, a “Matched Devices” item, a “Performances” item, a “Run” item, and a “View Results” item. The “Matched Devices” menu item may open a form in which selected matched devices can be entered from the schematic. The “Performances” menu item may open a form that displays all the defined output variables in the session for selection. The “Run” menu item may open a form that allows the user to name a directory where the results are saved and to start the mismatch analysis. Finally, the “View Results” menu item displays the saved results.

Referring to FIG. 2, a flowchart of a mismatch evaluation method 200 is depicted according to one exemplary embodiment of the invention. The mismatch method 200 may be performed by the mismatch tool 100 detailed in FIG. 1. In step 205, a nominal circuit simulation is evaluated to determine nominal circuit performance measures, including, for example, gain and/or phase margins. In step 210, a user selects matched devices. In one embodiment, the device selection may be made graphically on a circuit schematic appearing on a display device. In step 215, process parameters are identified from a model file for each matched device, and a list of parameters is compiled. The model file may be, for example, a SPICE model file. Each process parameter may be varied independently for every instance of the device in the circuit. In step 220, the standard deviation for each process parameter for each device instance is calculated. The standard deviation value may be dependent on geometry.

Steps 225, 230, 235, 240 and 245 together perform the mathematical operations of Equation 1. Specifically, in step 225, each process parameter, P, is permutated by one standard deviation (σₚ) one at a time. In step 230, a circuit simulation with a permutated process parameter is performed. The deviation from nominal for each circuit performance measure is evaluated and recorded in step 235. In step 240, if the simulation has not been repeated for each process parameter and for each matched device, control returns to step 225, otherwise control passes to step 245. In step 245, the standard deviation (σₑ) of the circuit performance due to mismatch is calculated as the sum of squares of the deviations for each circuit performance measure, P, across all process parameters and matched device.

The mismatch evaluation method 200 may be extended to more than just partitioning into device level and circuit level performances. It may be performed hierarchically for circuit blocks as well. In one embodiment, the device level variances are calculated and propagated to the block level, which requires only block simulations, not simulations of the entire circuit, and then the block level variations are propagated to the whole circuit level. When the number of electrical performance measures at one hierarchical level is greater than the number of electrical performance measures at the next higher hierarchical level, then fewer simulations are required and the process efficiency is greater.

In one embodiment, matched pairs of devices with symmetrical bias and geometry conditions (for example, differential pairs) may be combined into one source of device variation with double the normal mismatch variation. This reduces the number of altered process parameters, typically 9 to 11 parameters per device.

Still referring to the mismatch evaluation method 200, if sensitivities are available in a simulator, as is true for some simulators for DC and AC analysis, then these sensitivities may be used directly, which reduces the number of simulation runs, and hence time, for the analysis. Because the perturbations for the mismatch analysis are relatively small, results of an original run can be saved, and re-used as a starting point for subsequent runs, which reduces the computation needed to produce the results, and hence improves efficiency.

### EXAMPLE

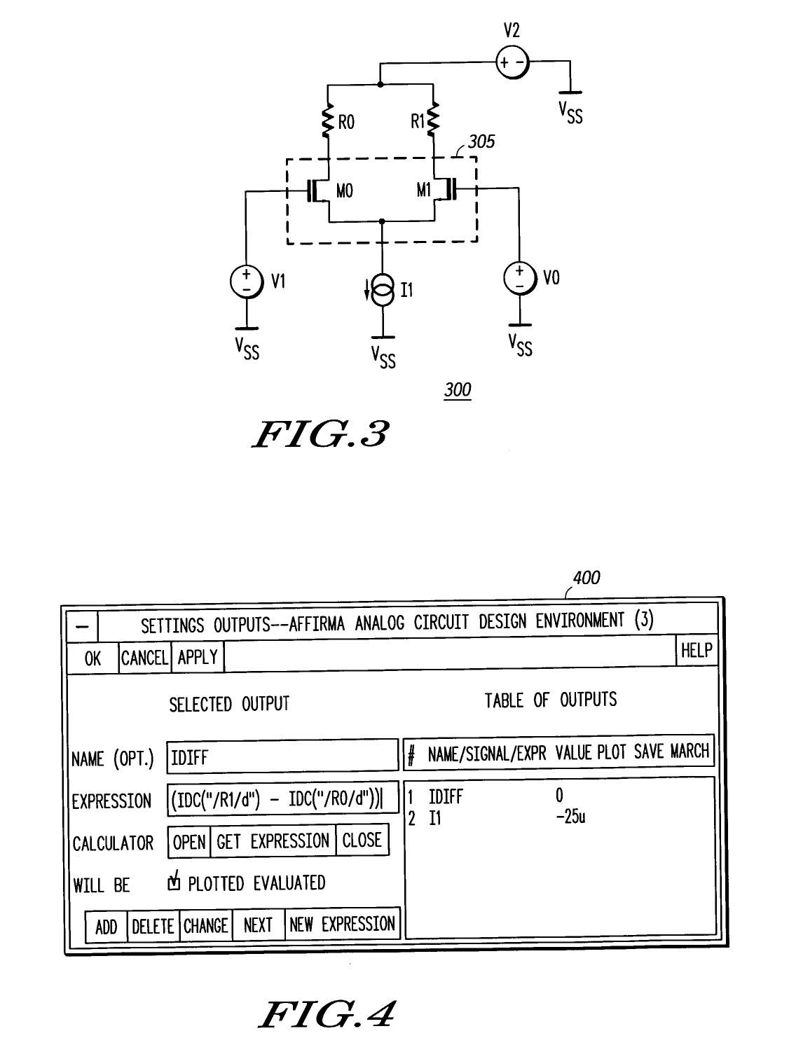

Referring to FIG. 3, a circuit diagram 300 created with the circuit simulation program 110 detailed in FIG. 1 is depicted. The circuit diagram 300 was used to illustrate an exemplary implementation of a mismatch evaluator 115 performing the mismatch evaluation method of FIG. 2. The differential pair 305 uses two NMOS devices in an RF BiCMOS technology. Ideally, the difference between the two transistor currents should nominally be zero since the circuit is perfectly symmetrical. However, due to mismatch effects, a differential current (Idiff) will have some distribution around a mean of zero. In this example, the performance measure Idiff is defined as the difference between the two transistor currents, and I1 is defined as the current in one of the transistors.

A simulator type may be chosen in the setup menu of the circuit simulation software 110. In this example, a DC analysis is chosen, corresponding to step 205 detailed in FIG. 2. Next, the two output variables (performance measures) Idiff and I1 are defined using a calculator as seen in the output setting window 400 detailed in FIG. 4.

In one embodiment, the mismatch evaluator 115 may allow any performance measure to be defined. For example, when simulating a transient analysis on the circuit, a point on the transient curve at an arbitrary time, an overshoot value or any other function may be defined. After defining the output variables, a simulation may be run to ensure that the circuit is devoid of any errors, and to generate a netlist of the schematic for mismatch evaluator use. Values for Idiff and I1 appear in the right down corner of the window 500 detailed in FIG. 5.

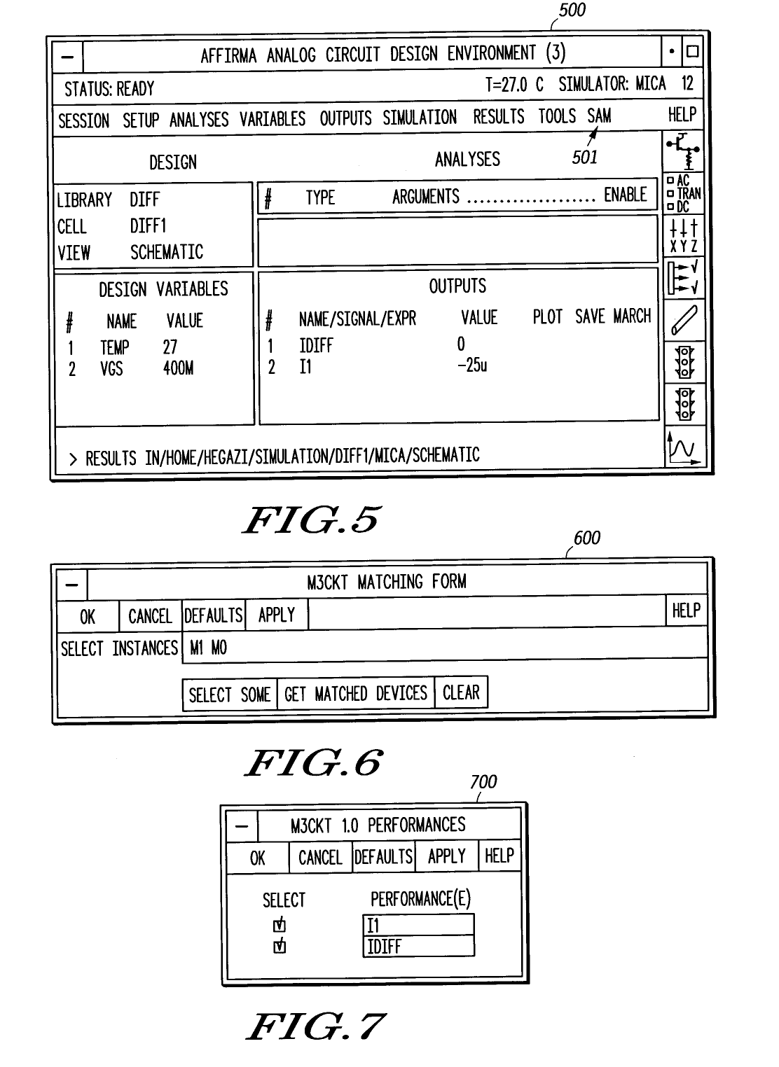

A mismatch evaluator menu may appear under the “SAM” menu item 501 in the window 500. When using the mismatch evaluator menu, the “Matched Devices” submenu item may be selected, and a matched device selection form 600 such as the one detailed in FIG. 6 may appear. This corresponds to Step 210 of FIG. 2. In the illustrated example, two devices MO and Ml may be selected, for example, by lassoing, using the left mouse button on the schematic and then pressing the button “Select Some” in the form 600.

Alternatively, the two devices M0 and M1 may be selected as matched devices using the property “Matched” in their chain description files (CDFs), and then be automatically entered into the form 600 by pressing the button “Get Matched Devices”. Both buttons may take into account the position of the devices in their respective hierarchies, if applicable.

After selecting the matched devices, the “Performances” submenu in the mismatch evaluator menu may be used. A performance form 700 opens as detailed in FIG. 7. The performance form 700 automatically ports all the performance measures defined, in this example Idiff and I1, and gives the user a chance to select which performance measures to perform the analysis on. In this example both Idiff and I1 are selected. This corresponds to Step 215 of FIG. 2.

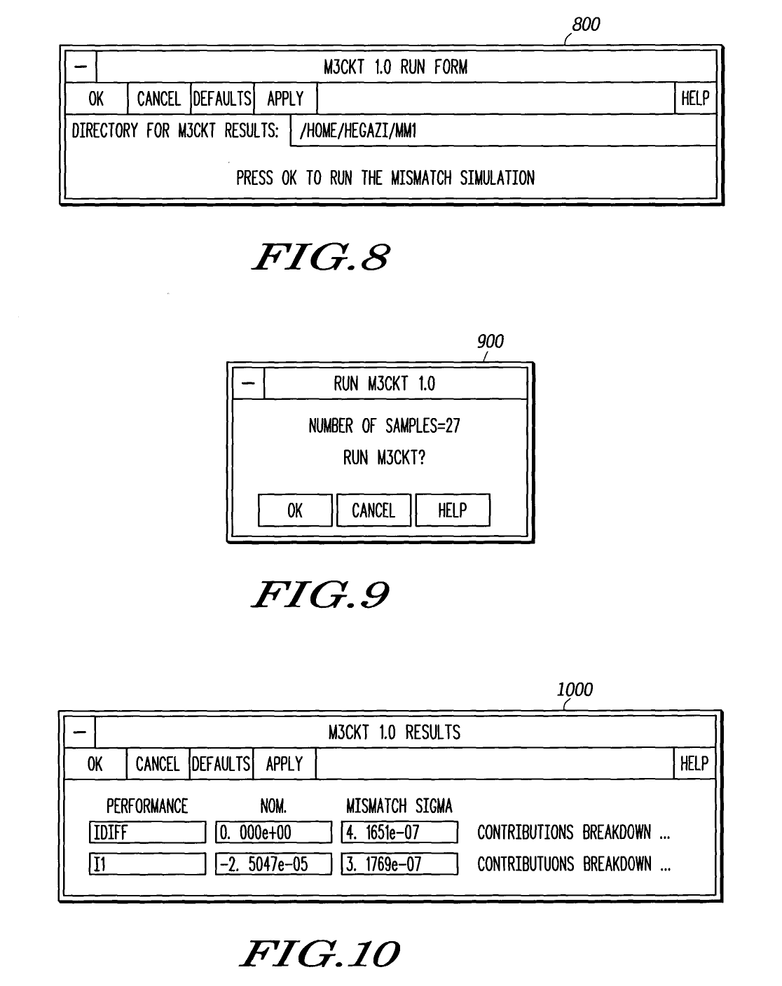

Next, a “Run” submenu item in the mismatch evaluator menu, may be used. The run submenu may allow the mismatch evaluator 115 to enter step 220 of FIG. 2. A run form 800 appears as shown in FIG. 8. At this point, a directory for saving results may be selected and the mismatch evaluator analysis may be initiated. A popup window 900 detailed in FIG. 9 may appear indicating the number of simulation runs that mismatch evaluator program will perform. This number is equal to the total number of process parameters plus one extra run for the nominal value of the performance at hand. Then, the mismatch evaluator actually starts the simulations, and each run number and its value may be printed in the Cadence Interface Window (CIW) sequentially until all the runs are complete. This function corresponds to the loop formed by Steps 225, 230, 235 and 240 in FIG. 2.

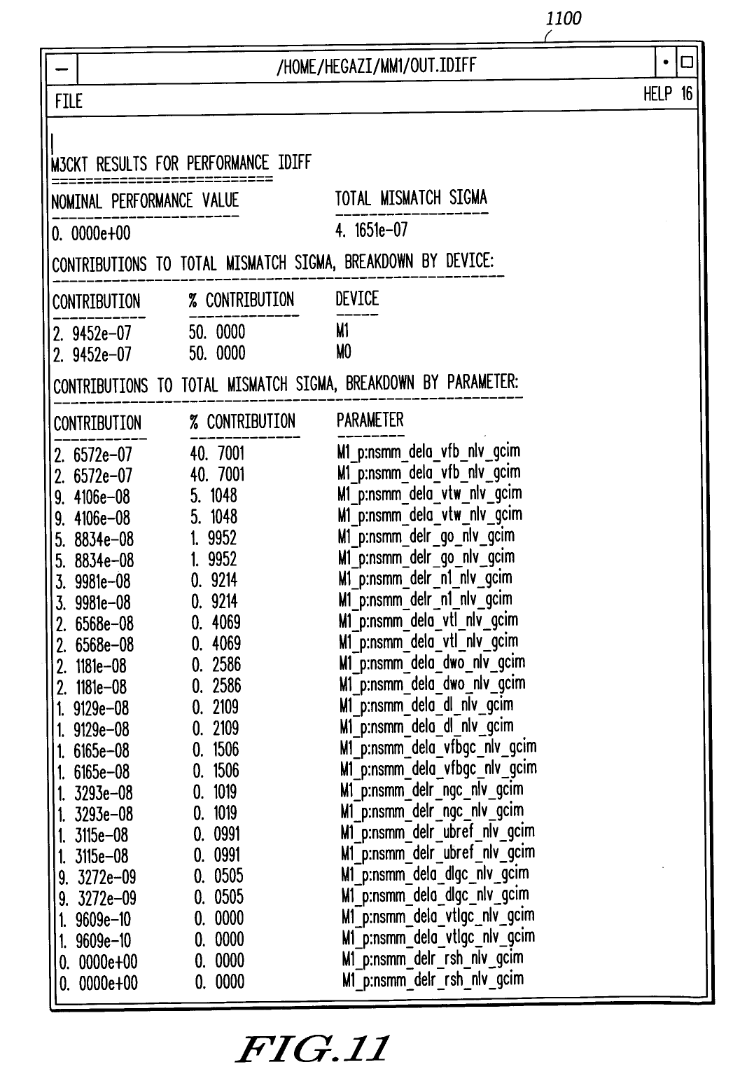

After all the simulation runs are completed, a results form 1000 detailed in FIG. 10 may be displayed. Form 1000 shows the nominal value of each performance measure and its total mismatch sigma, σₑ. Also, next to each performance result a “Contributions Breakdown” button which, when pressed, displays the detailed breakdown of the total mismatch sigma, sorted in descending order according to each device parameter percentage contribution to the total mismatch sigma. The detailed breakdown of contributions to the Idiff sigma 1100 is shown in FIG. 11. Form 1100 lists the values used in a square root, sum of squares method to obtain the total mismatch sigma, σₑ. This corresponds to Step 245 in FIG. 2.

In one embodiment, saved files may also include: a file containing the statistical parameters extracted from the model library file; a file that contains the results of the simulation runs for each performance; and a file, which contains the detailed breakdowns shown in FIG. 11 (the number and names of these files may correspond to the number and names of the performance measures chosen for the analysis).

Further, saved files may also include sample files. These files may contain the mismatch process parameters that are permuted by 1 sigma for the simulator used. The number of sample files may correspond to the number of runs as displayed in the popup window 900 of FIG. 9.

By analyzing the results in FIG. 11, it may be seen that, in this particular example, the two largest contributors to the mismatch in this example are: the flat band voltage vfb, and vtw (which accounts for the change in flat band voltage as a function of gate length). One of ordinary skill in the art will recognize in light of this disclosure that increasing the gate length in this example may reduce the mismatch contributions.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term program or computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method for evaluating component mismatch in a circuit, comprising:
performing a nominal circuit simulation;
selecting a set of matched devices from the circuit, each matched device having at least one process parameter associated therewith; and
evaluating a component mismatch in the circuit using a mismatch model described by:
$${σ}_{{E}_{k}}^{2} = {\sum }_{i , j} {( \frac{\partial {E}_{k}}{\partial {p}_{i , j}} )}^{2} {σ}_{{p}_{i , j}}^{2} ,$$
where:
P_{i,j} is an i^{th} fundamental process parameter for a j^{th} device;
Eₖ is a k^{th} circuit performance measure; and
σ is a standard deviation.

2. The method of claim 1, the evaluating step comprising using a modified mismatch model described by:
$${σ}_{{E}_{k}}^{2} = {\sum }_{i , j} {( \frac{\partial E}{\partial {e}_{j}} )}^{2} {( \frac{\partial {e}_{j}}{\partial {p}_{i , j}} )}^{2} {σ}_{{p}_{i , j}}^{2} ,$$
where:
eⱼ is an electrical performance for the j^{th} device.

3. A method for evaluating component mismatch in a circuit, comprising:
performing a nominal simulation of a circuit;
selecting a set of matched devices from the circuit, each matched device having at least one process parameter associated therewith;
altering one of the at least one process parameters by one standard deviation;
executing an altered circuit simulation using the altered process parameter;
determining a deviation from a nominal value of at least one circuit performance measure as a result of the altered circuit simulation; and
repeating the altering, executing and determining steps for each process parameter of each matched device.

4. The method of claim 3, wherein executing the nominal circuit simulation includes determining a circuit performance measure.

5. The method of claim 4, wherein the circuit performance measure includes a differential current.

6. The method of claim 3, wherein selecting the set of matched devices includes selecting a set of devices from a circuit schematic.

7. The method of claim 3, further comprising, compiling a list of process parameters associated with the selected set of matched devices.

8. The method of claim 7, wherein compiling the list of process parameters from the model file includes identifying process parameters from a device model file.

9. The method of claim 7, wherein compiling the list of process parameters associated with the set of matched devices includes compiling the list of process parameters associated with each device from the set of matched devices.

10. The method of claim 3, further comprising summing the squares of deviations for each circuit performance measure.

11. The method of claim 10, further comprising determining a mismatch contribution of each matched device to a total mismatch variation.

12. The method of claim 11, further comprising determining a mismatch contribution of each process parameter of each matched device to the total mismatch variation.

13. A program storage device, readable by a machine and tangibly embodying a representation of a program of instructions adapted to be executed by said machine to perform the method of claim 3.

14. A mismatch evaluation tool, comprising:
a computer;
a user interface coupled to the computer; and
a program storage device coupled to the computer, the program storage device embodying a mismatch evaluator which, at least:
allows a user to perform a nominal circuit simulation;
allows the user to select a set of matched devices, each matched device having at least one process parameter associated therewith;
alters one of the at least one process parameters by one standard deviation;
executes an altered circuit simulation using the altered process parameter;
determines a deviation from a nominal value of at least one circuit performance measure as a result of the altered circuit simulation; and
repeats the altering, executing and determining steps for each process parameter of each matched device.

15. The mismatch evaluation tool of claim 14, wherein the mismatch evaluator compiles a list of process parameters associated with the set of matched devices.

16. The mismatch evaluation tool of claim 14, wherein the mismatch evaluator sums the squares of deviations for each circuit performance measure.

17. The mismatch evaluation tool of claim 16, wherein the mismatch evaluator determines a mismatch contribution of each matched device to a total mismatch variation.

18. The mismatch evaluation tool of claim 17, wherein the mismatch evaluator determines a mismatch contribution of each process parameter of each matched device to the total mismatch variation.

19. The mismatch evaluation tool of claim 14, the program storage device further embodying a circuit simulation program.

20. The mismatch evaluation tool of claim 14, the program storage device further embodying a mismatch data library.
